(19) United States
(12) Patent Application Publication
(10) Pub. No.: US 2013/0056693 A1
(43) Pub. Date: Mar. 7, 2013

(54) LIFTING DEVICE

(71) Applicants: Richard Loyd Stevens, Urbandale, IA (US); Vincent L. Basile, II, West Des Moines, IA (US)

(72) Inventors: Richard Loyd Stevens, Urbandale, IA (US); Vincent L. Basile, II, West Des Moines, IA (US)

(73) Assignees: Larry A. Stevens, West Des Moines, IA (US); Norman R. Stevens, Des Moines, IA (US)

(21) Appl. No.: 13/596,270

(22) Filed: Aug. 28, 2012

Related U.S. Application Data
(60) Provisional application No. 61/530,042, filed on Sep. 1, 2011.

(51) Int. Cl. B66F 7/14; B66F 5/00; B66F 7/12

(52) U.S. Cl. 254/2 R; 254/89 R; 254/92

(57) ABSTRACT

A lifting device that raises persons with limited mobility from a first position, such as lying on the floor, to a second position, such as a sitting or standing position, and vice versa. The lifting device has a base, a plurality of supports which extend from the base and a platform connected to the supports. The platform travels upon the supports by way of a plurality of gears which are connected to a power source which is controlled by a controller. In this way the platform travels between a first position, such as adjacent the floor, and the second position, such as sitting or standing.

### CROSS REFERENCE TO RELATED APPLICATION

This application claims the benefit of U.S. Provisional Application No. 61/530,042 filed Sep. 1, 2011.

### FIELD OF THE INVENTION

This invention relates to a lifting device. More specifically and without limitation, this invention relates to a lifting device for lifting objects, including persons from a first position to a second position, and vice versa.

### BACKGROUND OF THE INVENTION

Many people suffer from mobility inhibiting conditions such as age related degeneration, a traumatic injury, a birth defect, a recent surgery, disease, obesity or various other defects. There are a plurality of devices which assist persons that suffer from limited mobility, such as elevators, wheel chairs, and articulating beds.

While the prior art devices assist with some forms of mobility and certainly improve the quality of life of persons that suffer from these conditions, there are still deficiencies in the prior art. Specifically, a particularly distressful situation occurs when persons with limited mobility are unable to raise themselves from the floor, such as when older persons fall to the floor. Currently, none of these devices adequately assist persons with limited mobility from raising themselves from the floor in a convenient and cost effective manner. Accordingly, there exists a need in the art for a device that addresses these deficiencies.

Therefore, an object of the present invention is to provide a lifting device that assists persons with limited mobility to raise themselves from a first position to a second position, and vice versa.

Another object of the present invention is to provide a lifting device that is mobile.

Yet another object of the present invention is to provide a lifting device that is cost effective.

These and other objects, features, or advantages of the invention will become apparent from the specification, drawings and claims.

### SUMMARY OF THE INVENTION

A lifting device that raises persons with limited mobility from a first position, such as lying on the floor, to a second position, such as a sitting or standing position, and vice versa. The lifting device has a base, a plurality of supports which extend from the base and a platform connected to the supports. The platform travels upon the supports by way of a plurality of gears which are connected to a power source which is controlled by a controller. In this way the platform travels between a first position, such as adjacent the floor, and the second position, such as sitting or standing.

### BRIEF DESCRIPTION OF THE DRAWINGS

FIG. 1 is a perspective view of a lifting device;

FIG. 2 is a perspective view of a collapsible lifting device; and

FIG. 3 is a perspective view of a lifting device having an air bladder.

### DETAILED DESCRIPTION OF THE PREFERRED EMBODIMENT

With reference to the figures, a lifting device 10 is presented. The lifting device 10 has a base 12. The base has at least one, and preferably a plurality of supports 14 which are connected to and extend upwardly from the base 12. At their lower end 16 supports 14 are connected to base 12, at their upper end 18, supports 14 are connected to rest member 19. Connected to supports 14 between their lower end 16 and their upper end 18 is platform 20.

Base 12 is of any size and shape which allows base 12 to adequately and rigidly support lifting device 10. Preferably base 12 is made of a sturdy but light-weight material such as wood, composite, plastic, aluminum, or any other suitable material. Preferably, base 12 is thin in vertical height with a flat bottom surface 22 so as to sit flushly on the floor and a flat upper surface 24 so as to minimize its vertical height. Alternatively, the upper surface 24 is arcuately curved or dished so as to ergonomically conform to the human body and provide a more comfortable sitting surface. To further reduce the weight of the device, yet without reducing the structural rigidity or strength of device 10, base 12 has an opening of any size and shape which is preferably placed in the center of base 12. Base 12 connects the bottom end of all supports 14 to one another to improve rigidity.

Supports 14 are preferably connected to base 12 at their lower end 16 by passing a portion of support 14 through base 12 and bolting the support 14 to the base 12. However, any other means may be used to connect support 14 to base 12 such as a snap fit arrangement, screwing, gluing, welding or forming the base and the supports from a single solid piece of material, or the like means. Supports 14 are connected to rest member 19 at their upper end 18 in a similar manner. The supports 14 extend between base 12 and rest member 19 in parallel spaced alignment to one another. Preferably supports 14 are solid or hollow threaded metal rods of fixed and equal length. Supports 14 can also have a non-threaded portion 14A which connect to and extend above the threaded portion. In a preferred arrangement, three supports 14 are used in a triangular arrangement when viewed from above. One support 14 is positioned adjacent either side of the front side 26 of device 10 and one support 14 positioned in the center of the rear side 28 of the device 10. This arrangement allows for easy ingress and egress while providing rear support for the user. Alternatively, the use of one, two, four, or more supports 14 is hereby contemplated. In addition, a flexible and collapsible sheath 30 covers supports 14 and extends between base 12 and platform 20, and platform 20 and rest member 19 so as to prevent users from being injured by the threads of supports 14.

Rest member 19 extends across and connects each upper end 18 of supports 14 to one another. In this way, rest member 19 provides additional rigidity and support for the device 10. Preferably, rest member 19 extends in an arcuate U-shaped fashion terminating at opposing ends 32 which extend just past each opposing support member 14 positioned adjacent front side 26 of device 10. This arrangement allows the user easy ingress and egress to the front of the device while simultaneously providing rear support for the user.

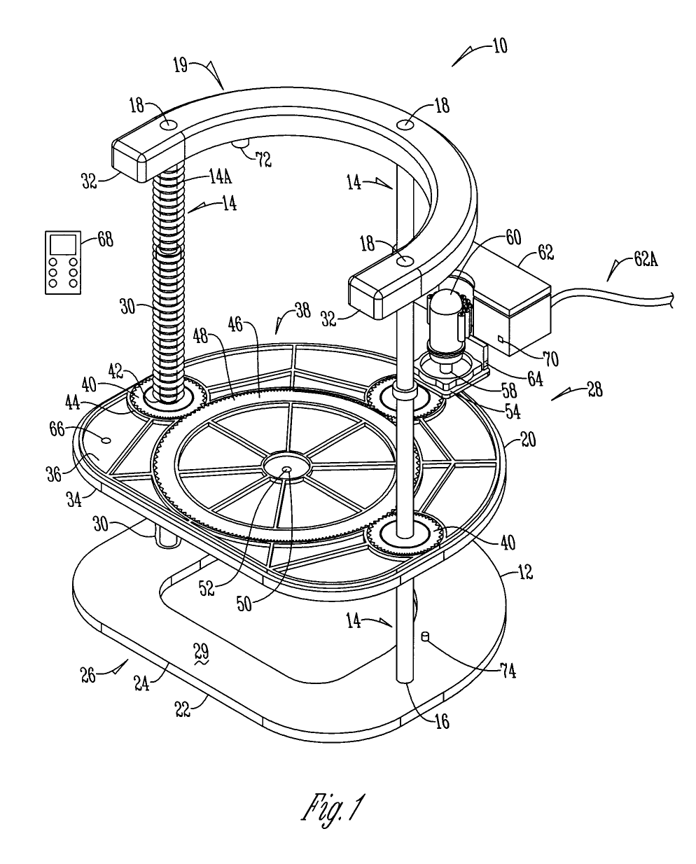

Platform 20 is moveably and controllably connected to supports 14. Preferably platform 20 has a flat bottom surface 34 and a flat upper surface 36 which extend in parallel spaced alignment. Alternatively, the bottom and upper surfaces 34, 36 are arcuately and ergonomically designed to comfortably accommodate a user. Positioned within platform 20 is lifting mechanism 38 which is any arrangement which raises and lowers platform 20 upon supports 14. In one embodiment, lifting mechanism 38 has a driven gear 40 connected to each support 14. Driven gear 40 extends between an interior edge 42 and an exterior edge 44. Interior edge 42 contains threads which match, matingly receive and intermesh with the exterior threads of support 14 such that when driven gear 40 is rotated in one direction it travels upwardly along support 14, when driven gear 40 is rotated in the opposite direction it travels downwardly along support 14. Exterior edge 44 contains a gear-teeth arrangement. Lifting mechanism 38 also has a sun gear 46. Sun gear 46 has an exterior edge 48 which contains gear-teeth which match, matingly receive and intermesh with gear-teeth of driven gear 40 such that when sun gear 46 rotates, driven gears 40 similarly rotate. Sun gear 46 and driven gears 40 are sized such that sun gear 46 engages and rotates all driven gears 40 simultaneously. As pictured in FIG. 1, this means that as sun gear 46 rotates, all three driven gears 40 simultaneously rotate. Supports 14 are arranged in a balanced triangular arrangement such that sun gear 46 is trapped within the supports 14 and cannot escape laterally. This eliminates the need to connect sun gear 46 to an axel, thereby allowing sun gear 46 to be a hollow gear which reduces both the cost and the weight of device 10. Alternatively, an axel 50 is connected to the center of sun gear 46 so as to provide additional support, strength and rigidity by requiring sun gear 46 to spin upon axis 52. While a gear-arrangement is described herein, a chain-arrangement can be used, as well as a belt-arrangement as well as any other similar mechanical arrangement with similar or identical results.

A driver gear 54 is connected to the lifting mechanism 38. Driver gear 54 has an exterior edge 56 which contains gear-teeth which match, matingly receive and intermesh with gear-teeth of driven gear 40 and/or gear-teeth of sun gear 46 such that when driver gear 54 is rotated, driven gears 40 and sun gear 46 simultaneously rotate. As pictured in FIG. 1, preferably, driver gear 54 is connected to the rear 28 side of the driven gear 40 which is connected the rearwardly positioned support 14. Alternatively, driver gear 54 is connected to any other gear of lifting mechanism 38. Driver gear 54 is connected to axel 58 which is controllably rotated by reversible motor 60 which extends outwardly and/or above platform 20 so as to not interfere with the bottom surface 34 of platform 20 for engaging the upper surface 24 of base 12. Motor 60 is connected to power source 62 which can include portable batteries or a battery pack, a conventional electrical plug, a generator, a fuel-powered motor, a tank of compressed air, an air compressor, or any other source or power or a combination of these sources of power. In the event power source 62 is a battery, a rechargeable battery or an array of batteries, preferably said battery is an AC/DC adaptable battery that is chargeable/rechargeable by plugging electrical cord 62A into a conventional electrical outlet. Alternatively, said battery is removable and replaceable as is known in the hand tool art (such as a removable rechargeable cordless drill motor battery). Motor 60 is connected to a controller 64 which includes any device which activates and deactivates the operation of lifting mechanism 38 such as a switch 66 which is connected to platform 20, or a remote 68 which is wirelessly connected to a receiver 70 which is connected to and activates, deactivates and controls motor 60.

In operation, in a first position, and lowermost position, the bottom surface 34 of platform 20 engages the upper surface 24 of base 12. In this position, the upper surface 36 of the platform 20 is only a very limited distance above the surface of the floor, which makes it easy for users with limited mobility to pull themselves onto platform 20. In this position, the user pulls themselves onto the upper surface 24 of platform 20, between opposing supports 14 on either side of the front 26 of device 10. In this position, the user can lean their back against rest member 19 which secures the user on platform 20. Once the user is positioned upon the platform 20 the user engages either the switch 66 which is directly connected to the device or the remote 68 which is wirelessly connected to receiver 70. In either case, when controller 64 is activated power flows from power source 62 which activates motor 60. Motor 60 rotates axel 58 and driver gear 54. When driver gear 54 rotates, the gear-teeth on its exterior edge 56 engage with the gear-teeth on the exterior edge 44 of driven gear 40 which is connected to the support 14 which is positioned at the rear 28 of device 10. Alternatively, the gear-teeth of driver gear 54 engage the gear-teeth on the exterior edge 48 of sun gear 46. Either way, the rotation of driver gear 54, rotates each driven gear 40 connected to each support 14. Torque and rotation is transferred from the driver gear 54 through the sun gear 46 to all driven gears 40. As the driven gears 40 rotate, the threads on the interior edge 42 interengage and slide upon the threads on the exterior surface of supports 14. In this way the, platform 20 is raised. As the platform 20 raises, the sheath 30 connected between the base 12 and the platform 20 extends to cover the threads of the support between the base 12 and the platform 20, in contrast, the sheath 30 connected between the platform 20 and the rest member 19 simultaneously compresses. This process continues until the user deactivates the motor 60 or until the platform reaches a second position, or highest position, wherein the platform will trip an upper limit switch 72 which is connected to platform 20, a support 14 and/or rest member 19. In the second position, the upper surface 24 of platform 20 engages the bottom surface of rest member 19 at which point limit switch 72 deactivates motor 60 and the platform 20 has reached its maximum height.

The opposite process takes a user from the second position, or highest position to the first position, or lowermost position. In this process the motor 60 rotates in the opposite direction, thereby causing the gears, 54, 46, 40 to rotate in the opposite direction until the motor 60 is deactivated or the lower limit switch 74 which is connected to the base 12, a support 14 or the platform 20 is engaged at the first position wherein the bottom surface 34 of platform 20 engages the upper surface 24 of base 12. In this way, platform 20 is infinitely adjustable to any position between the first position and the second position to suitably accommodate the user's needs to raise or lower them from one position to another.

In an alternative embodiment, lifting mechanism 38 is arranged such that supports 14 rotate within their connection to base 20 and rest member 19 and driven gears 40 remain static within platform 20. In this arrangement sun gear 46 engages and rotates supports 14 which allows lifting mechanism 38, including sun gear 46 to be positioned within base 12. This arrangement provides a similar yet different way of accomplishing the same result.

In an alternative embodiment, driven gears 40 are independently controlled. Specifically, to assist the user with standing from a sitting position, the rearwardly positioned driven gear 40 is independently activated by motor 60 such that the user can tilt platform 20 so as to assist with going from a sitting position to a standing position or vice versa. As the rearwardly positioned driven gear 40 travels upwardly on the rearwardly positioned support 14, while the forwardly positioned driven gears 40 and supports 14 remain static the angle of platform 20 changes. This requires the supports to give, bend or angle towards one another as the angle of platform 20 increases, or deviates from parallel to the base 12. This angular give can be accomplished by using a flexible joint between supports 14 and base 12 and rest member 19 and supports 14 such as a ball and socket joint, hinge, rubber bushings, or the like. In this way platform 20 can be tilted to assist with sitting or standing.

In an alternative embodiment, instead of using supports 14 which are static threaded rods, extending or telescoping supports 14 are used which have a plurality of pieces which interengage and slide upon one another to raise and lower platform 20. These telescoping pieces of support 14 are controlled by pneumatic or hydraulic pressure, or through any other mechanical means. This includes the use of a cylinder with an arm that protrudes from and retracts into the cylinder to raise and lower platform 20.

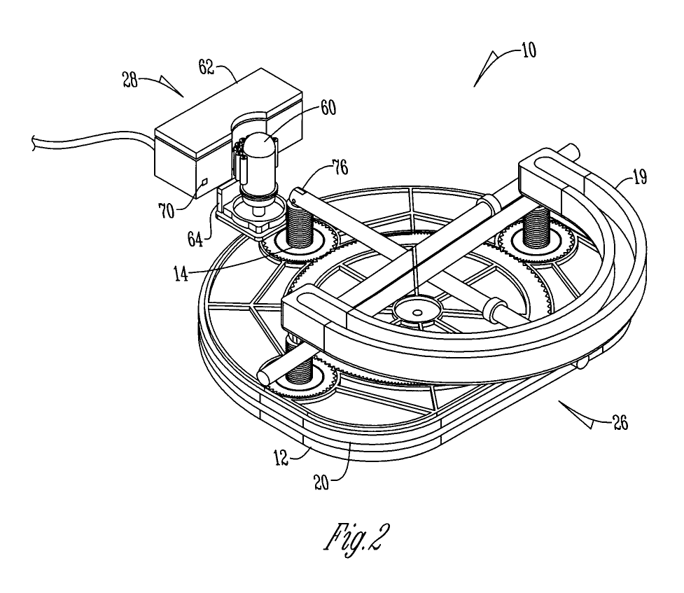

In an alternative embodiment, with reference to FIG. 2, a collapsible version of device 10 is presented. In this arrangement, supports 14 have joints 76 therein which allow supports 14 to fold. When supports 14 are in a folded position, device 10 occupies a smaller volumetric space which allows for easier shipping, transport and use. As can be seen in FIG. 2, the supports 14 are also extendable/collapsible to further allow for adjustment as well as space savings.

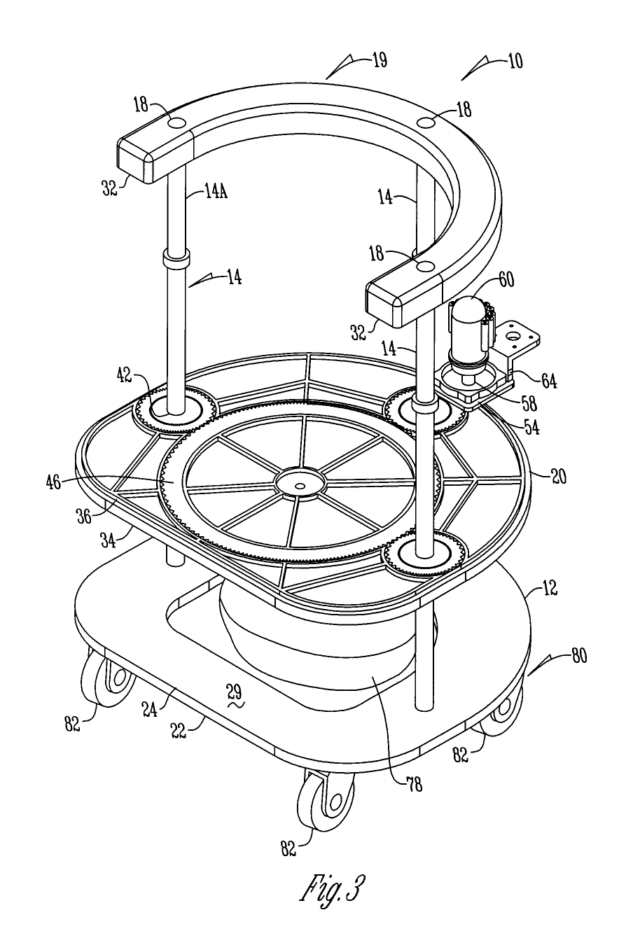

In an alternative embodiment, with reference to FIG. 3, an air bladder 78 is positioned between base 12 and platform 20. In this arrangement, when air bladder 78 is inflated by way of activating controller 64 through switch 66 or remote 68, platform 20 is raised; as air bladder 78 is deflated platform 20 is lowered. In one arrangement, air bladder 78 is contained within column 79, which retains air bladder within the column 79 and prevents air bladder 78 from extending beyond the desired area. Preferably, column 79 is a vertically compressible tube with a cylindrical opening in which the air bladder 78 resides. In this arrangement sun gear 46 can be eliminated leaving driven gears to rotate freely upon supports 14. Alternatively, driven gears 40 are also eliminated as well as the threads on supports 14, allowing platform 20 to freely slide upon supports 14, which merely act as smooth rails or guides.

In an alternative embodiment, device 10 is equipped with a smart mobility assembly 80. Mobility assembly 80 has a plurality of retractable wheels 82, at least one of which is driven by a power source and motor 84. When the wheels 82 are retracted the bottom surface 22 of base 12 is flush with the floor; when wheels 82 are not retracted base 12 is spaced above the floor. Mobility assembly 80 is equipped with and connected to controller 64 and remote 68, such that when a user needs lifting device 10, the user activates the mobility assembly 80 through remote 68. When activated, mobility assembly 80 drives lifting device 10 to the location of the remote 68 through use of power source 62. Once there, the wheels 80 are automatically retracted and the user is able to use lifting device 10 as described above at a remote location thereby providing a mobile lifting device 10 when and where it is needed.

From the above discussion it will be appreciated that provided is a lifting device that provides a convenient method and means to assist those with limited mobility to raise themselves from a first position to a second position that improves upon the state of the prior art. Accordingly, the lifting device presents many advantages over the prior art.

It will be appreciated by those skilled in the art that other various modifications could be made to the device without parting from the spirit and scope of this invention. All such modifications and changes fall within the spirit and scope of the claims and are intended to be covered thereby.

What is claimed:

1. A lifting device for the assistance of disabled persons, comprising:
a base;
a plurality of supports connected to the base;
a platform positioned above the base and connected to the plurality of supports;
a motor connected the platform;
a controller connected to the motor;
wherein when activated, the motor raises and lowers the platform between a first position to a second position;
wherein the second position is above the first position.

2. The lifting device of claim 1 wherein when the platform is in the first position the platform a bottom surface of the platform engages a top surface of the base.

3. The lifting device of claim 1 wherein a rest member is connected adjacent a top end of the plurality of supports.

4. The lifting device of claim 1 wherein the motor is connected to a driver gear.

5. The lifting device of claim 1 wherein a sun gear is positioned within the platform.

6. The lifting device of claim 1 wherein a driven gear is connected to each of the plurality of supports.

7. The lifting device of claim 1 wherein each of the plurality of supports has a threaded exterior surface.

8. The lifting device of claim 1 wherein each of the plurality of supports is extendable.

9. The lifting device of claim 1 wherein a driven gear is positioned around a threaded exterior surface of each of the plurality of supports such that when the driven gear rotates it travels vertically along the surface of said support.

10. The lifting device of claim 1 further comprising an upper limit switch connected to the lifting device, wherein when the upper limit switch is actuated the motor is deactivated thereby stopping the upward travel of the platform.

11. The lifting device of claim 1 further comprising a lower limit switch connected to the lifting device, wherein when the lower limit switch is actuated the motor is deactivated thereby stopping the downward travel of the platform.

12. The lifting device of claim 1 further comprising a smart mobility assembly having a plurality of wheels and a controller, wherein the plurality of wheels and the controller drive the lifting device to a desired location.

13. The lifting device of claim 1 further comprising a remote which is wirelessly connected to the controller which remotely and wirelessly actuates the motor.

14. A lifting device for the assistance of disabled persons, comprising:
a base;
a platform positioned above the base and connected to the plurality of supports;
the platform having a sun gear and a plurality of driven gears;
each of the plurality of driven gears having threads on an interior edge;
wherein the sun gear is meshingly engaged with each of the plurality of driven gears;
each driven gear is threadably engaged around one of the plurality of supports,
a motor connected the platform;
the motor having a driver gear;
a controller connected to the motor;
the driver gear connected to the sun gear and the plurality of driven gears;
wherein when activated, the motor rotates the driver gear which rotates the driven gears and the sun gear thereby raising and lowering the platform between a first position to a second position;

15. The lifting device of claim 14 wherein the driver gear, the plurality of driven gears and the sun gear aligned in a flat plane.
